(19) United States
(12) Patent Application Publication
(10) Pub. No.: US 2012/0150631 A1
(43) Pub. Date: Jun. 14, 2012

(54) Key influencer-based social media marketing

(76) Inventors: Adam Matthew Root, Dallas, TX (US); Lindsey Ann Root, Dallas, TX (US)

(21) Appl. No.: 12/928,281

(22) Filed: Dec. 8, 2010

(51) Int. Cl. G06Q 30/00; G06Q 90/00; G06F 3/01

(52) U.S. Cl. 705/14.49; 715/753; 705/500

(57) ABSTRACT

A method for engaging social network users comprises the steps of searching for relevant keywords across social networks, blogs, forums, and the like; filtering conversations that contain relevant keywords to show only conversations near a business location; and responding to location-based conversations, driving potential customers to a call-to-landing page, whereby one has a one-on-one conversation at or about a specific geographic location with people having a conversation relevant to a particular business.

### I. FIELD

The present invention concerns advertising. In particular, the present invention concerns improving advertising by increasing the number of, and gaining recommendations from, key influencers.

### II. DESCRIPTION OF RELATED ART

Targeted marketing, where advertisements are sent to consumers based upon them having traits desirable to a particular business, enables advertisers to spend less money for a successful advertising campaign. Targeted marketing is especially effective when an advertisement is delivered to a consumer at or wanting information about a location serviced by a particular business, who has expressed an interest in what is being advertised, and when the advertising takes the form of a personal, one-on-one recommendation from a trusted friend.

Against this backdrop, there is a massive paradigm shift underway with regard to marketing, advertising, and public relations (PR). The paradigm shift involves the use of social media, which is an umbrella term that embraces the use of text, audio, video, and multimedia for communicating with friends, business clients, and potential customers; that is, using web-based technologies to turn communications into interactive dialogs, exchanging “consumer-generated content” or CGC. The use of social media tools to communicate and connect with others is called social networking. A multitude of online social media websites, or platforms—including Facebook, YouTube, Twitter, Foursquare, Gowalla, and LinkedIn—facilitate social networking.

Social media and social networking is huge, and growing. As of October 2010:

1. 3 out of 4 Americans use social media. The number of users is growing every day.

2. Americans love social networks. Each day more than 35 million users update their status on Facebook, watch 100 million videos on YouTube, and post 27.5 million tweets on Twitter. Social networking is a large part of American culture, and this trend is accelerating.

3. Social media is the #1 activity on the Internet.

4. 1 out of every 8 couples married in the U.S. met via social media.

5. 96% of Millennials (people born between 1977 and 1995) have joined a social network. There are 80 million of them. They are a primary group of potential clients and customers (and, again, 96% of them have joined a social network). Baby Boomer CEO's and other business managers born before 1977 frequently overlook the significance of social media marketing as they aren't as active in social media as their younger customers.

6. The fastest growing segment of social media users is those over 35—people with money to spend on products and services, and who want to collect as much information as they can about them.

7. There are 200,000,000 Internet blogs.

8. There are currently more that 500,000,000 Facebook users. If Facebook were a country, it would be the third largest in the world (behind China and India).

9. 83% of all companies use Facebook.

10. 5 billion minutes (over 83 million hours) are spent on Facebook every day. Many Americans spend 4 hours a day on Facebook.

11. Whereas ubiquitous technology enables Americans to “fast forward through” or otherwise skip television advertising, American cannot and do not skip Internet advertising, especially when the advertising comes in the form of a comment from a trusted friend. Not only do they not skip such advertising, they are often enthused to see it and consider it carefully.

12. 97% of online Americans say that they are more likely to try a product or service if a social media friend recommends it.

13. 24 of the 25 largest newspapers are experiencing record declines in circulation.

14. YouTube is the second largest search engine in the world.

15. Twitter averages 50 million tweets per day.

In sum, the paradigm shift involves using social media for marketing, advertising, and conducting PR, because the number of people using social media is huge, and growing; and because social media users are great potential customers. Traditional alternative places for advertisements—such as television and newspapers—are declining in significance because they reach a shrinking number of people and their advertisements can easily be ignored.

The social media marketing opportunity is frequently presented in the form of a question: “If there was an expo having 250 million attendees, and you were offered a free booth at the expo, would you take advantage of the opportunity to promote your goods and services?” Increasingly, for many businesses, the answer is “yes.”

Social media advertising is especially well suited for small businesses. Since the fall of 2008, at the beginning of the American economic implosion, small businesses have had to reduce staff, trim marketing budgets, curtail production, and reduce offered services to just a few highly-profitable core services to gain staying power. However, a huge opportunity to participate in the social media space exists in front of small businesses. Via smart and cost-effective participation in social media, small businesses stand to establish a strong and effective presence in the social media universe, and drive increased business to their digital door.

While content at a number of social media networks, blogs, forums, and the like contains information about the location and interests of the people generating that content, an advertiser has heretofore been unable to get and use that information to target marketing by increasing the number of, and getting recommendations from, key influencers. For example, U.S. Pat. No. 7,668,832, which is hereby incorporated herein by this reference thereto because it contains a detailed amount of information about getting and using location data, and discusses use of location data to better place Website ads, but it fails to discuss how location data, coupled with systems for maximizing the number of key influencers and getting them to recommend a product a service, enables construction of effective advertising. There is, therefore, a need for a system and method to enable advertisers to get and use information on social media networks, blogs, forums, and the like, for more effective marketing.

### III. SUMMARY

In a particular embodiment, a method for marketing includes the steps of determining characteristics of key influencers, setting search parameters based upon the determined characteristics, searching social media feeds for possible key influencers, and targeting possible key influencers with comments.

In embodiments of the present invention, the comments may be location based or back link comments.

Other embodiments may include the step of creating custom content that appeals to key influencers, which content may be posted to a blog, used for updating status, or posted as a response to a comment.

Still yet other embodiments may include the step of sending email messages including a call-to-action and share buttons to key influencers.

In another particular embodiment, a method for localizing the Internet and engaging the localized Internet (which may be practiced by a system) includes the steps of aggregating feeds from a plurality of online sources, filtering the aggregated feeds to generate a list of online conversations having a select interest and seeking information about or coming from a select location, and engaging in at least one online conversation having a select interest and seeking information about or coming from a select location, whereby one has a one-on-one conversation at or about a specific geographic location with people having a conversation relevant to a particular business.

In embodiments of this method, the geographic location may be defined by a regular geometric shape, or it may be defined by an irregular geometric shape.

In another particular embodiment, a system for delivering custom content to a person based upon their location includes a first subsystem that interfaces with a plurality of programs and generates a list of conversations mentioning a select topic and seeking information about or coming from a select location, and a second subsystem that enables a person to participate in the listed conversations.

One particular advantage provided by embodiments of the claimed system and method is to enable businesses to deliver highly targeted and actionable conversations across the vast network of social media platforms. Embodiments of the present invention can drive traffic to call-to-action pages, providing trackable, measureable conversion. Embodiments of the present invention give a social template for success and profit.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a chart that schematically shows strategy underlying systems and methods of the present invention;

FIG. 2 is a chart that shows activity sets that can be combined in embodiments of the present invention;

FIG. 3 is a flow chart showing how location based comments may be made;

FIG. 4 is a flow chart showing how back link comments may be made;

FIG. 5 is a plan view of a possible call-to-action landing page including a conversion form;

FIG. 6 illustrates possible commenting in embodiments of the present invention;

FIG. 7 is a block diagram of a particular illustrative embodiment of a system for engaging the localized Internet;

FIG. 8 is a block diagram of a particular illustrative embodiment of a system for delivering content to a person based upon their location;

FIG. 9 is a flow chart of a particular illustrative embodiment of a method for posting custom content on blogs in embodiments of the present invention;

FIG. 10 is a flow chart of a particular illustrative embodiment of a method for updating status with custom content in embodiments of the present invention;

FIG. 11 is a flow chart of a particular illustrative embodiment of a method for commenting with custom content in embodiments of the present invention; and

FIG. 12 is a flow chart of a particular illustrative embodiment of a method for using email marketing in embodiments of the present invention.

### V. DETAILED DESCRIPTION

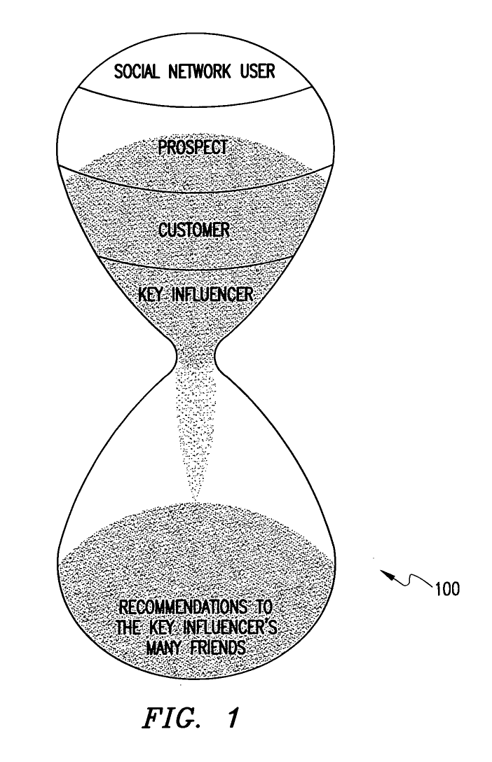

Referring to FIG. 1, a process, generally designated 100, is shown as an hourglass to explain the strategy behind practice of the present invention. Process 100 can be executed by any business (e.g., a social media marketing firm) on behalf a client business. This business may have a “partner” who is responsible for the way the business acts for the client business.

The goal of process 100 is to increase business. Exactly what is increased business depends upon what the client business does. In the case of a restaurant, increased business is a larger number of people in seats. In the case of clothing store, increased business is more visits by people who want the clothes. Demographics—the characteristics of the clients or customers—plays an important role. For example, the net worth of the client or customer (as is often reflected by the value of homes where they live) often defines the type of restaurant they like to go to (that is, one having inexpensive meals for people with low net worth; and one having expensive meals for people having a high net worth). Net worth also plays an important role in the type of store a person goes to. There are stores with inexpensive clothing for people with low net worth, and stores with expensive clothing for people with high net worth. Another demographic factor that plays an important role with regard to a store a person goes to is age. There are stores for “young” people, and stores for “older” people. Still yet another demographic factor that plays an important role with regard to a restaurant or store a person goes to is race. There are restaurants and stores that cater to people of one race versus another. Sex is another, often important demographic factor. There are stores that cater to males as opposed to women, and vice versa. Still yet another important demographic characteristic is ethnicity. There are stores (like grocery stores) that cater to people of one ethnicity versus another (like Koreans). A person from Korea is more likely to stop in a Korean grocery store that someone who is not. Traditionally used demographic factors are 1) age, 2) gender, 3) income level, 4) race, and 5) ethnicity.

With regard to social media, information that people create to share with family and friends can often easily be collected. All of that information is deemed (either by “policy” or by law) publically available, by the person creating it, at the time it was created. This information may be publically available by “policy” where the information is posted, it may be in one of many available chunks of data collected when the collected information was considered publically available by “policy” (assuming that the “policy” changed), or it may be legally available putting aside “policies” (for example, whereas Facebook presently considers the list of friends not to be information that should be available publically, it can easily and legally collected as follows: Replace USERID in the following URI with a Facebook user's ID number and load the URI: http://www.facebook.com/ajax/typeahead friends.php?u=USERID&_a=1. This renders JavaScript Object Notation that includes a list of the user's friends, including names and profile links).

Here, in chart form, is a list of some of the types of information about people that can be collected by social media aggregation software.

| Data | Revealed By |
|---|---|
| Names | Virtually always considered to be |
| | publically available information |
| Profile Photo | Virtually always considered to be |
| | publically available information |
| Networks | Virtually always considered to be |
| | publically available information |
| Gender | Virtually always considered to be |
| | publically available information; profile |
| | photo |
| Age | Birthday; dates that events occurred (e.g., |
| | graduation); ages of friends |
| Income Level | Current position; location of home |
| Race | Profile photo |
| Ethnicity | Profile photo |
| Sexual preference | Often specified in terms of “looking for |
| | ”; marital status |
| Likes and Interests (e.g., | Often specified; identify of friends; |
| favorite music, films, TV | comments |
| shows, political persuasion) | |
| Contact information | Often specified |
| (including website, phone | |
| number, physical address, | |
| and email address) | |
| Personality | Words used in comments; comments made |
| | by others |
| Medical issues | Personal comments; comments made by |
| | others |
| Financial issues | Personal comments; comments made by |
| | others |
| Personal issues (e.g., | Personal comments; comments made by |
| relationships with others) | others |

In addition to demographic data, geographic location is often very important. For example, people often go to places of business near where they live or work. In a rough way, geographic location can be determined by using a radius around a certain point. This is rough because the circle around the certain point will often include neighborhoods and other areas containing people who lack the desired demographic characteristics. For example, a circle with a 10-mile radius around a jewelry store will likely include neighborhoods containing people that would not be interested in and/or could afford the jewelry. In a more precise way, geographic location can be determined by calculating an irregular shape around a business, where target areas are included within the shape, and non-target areas are not. Much more information about mapping location is included in U.S. Pat. No. 7,668,832, which is incorporated by reference herein.

Location data about a person can be collected any number of ways. For example, location enabled social media sites include location data in Application Programming Interface (API) feeds. These API feeds can be accessed by anyone. The location data can comprise data captured by any one or more of a number of positioning technologies, such a GPS (positioning is determined by satellites), Assisted-GPS or A-GPS (takes the known location of a base station and provides synthetic or seed data to a mobile device's GPS chip to improve the speed of GPS signal acquisition), Network Base Station Database (e.g., since mobile devices are associated with a wireless access point/base station, it is possible to use the position of the base station as a proxy for the location of the device), Network Triangulation (signal strength-based), Network Triangulation (time-based), information about location given by the individual (e.g., in a comment or in a profile), a hybrid approach (e.g., since A-GPS requires a location estimate to start with, other less accurate location technologies can be leveraged to seed the A-GPS algorithm), or even some other positioning technology that is developed henceforth.

Here is an example of how people are using available information today. With email and contact information, those people are adding the email owners to a location-based social web service (like Foursquare, or Gowalla). In some cases their work is minimized because people use services (like Twitter) with geo-location enabled. Then, the people monitor check-in activity, matching it up with updates. Using this process, they are able to figure out which clients the email owner talks to, who their current clients are, where their key personnel spent time, and so on. Among the many questions these people can answer: Whom is your ex-girlfriend going to dinner with? Which church do you attend? Which mosque? Which gay bars? Why was your secretary with you when you checked into a motel at lunchtime? Why do you regularly go to an area of town known to be an easy source of drugs? And so on.

Process 100 drives action in two ways. First, process 100 drives people down the upper part of the hourglass—from a social network user, to a prospect, to a customer and finally to a key influencer. Second, process 100 drives recommendations down the bottom part of the hourglass, that is, causing a key influencer for a certain demographic to recommend a particular product or service to their friends.

Process 100 begins with a business collecting email addresses for a client business. The email addresses will be for all customers (total email addresses) and for those people the client business considers its key influencers (key influencer email addresses). The key influencers are a businesses' best clients or customers—people who are loyal—people who are the client businesses' “brand ambassadors.”

In process 100 the key influencers are for a certain demographic depending upon the particular client business. The client business will likely have a certain desired demographic (that is, it will appeal to people of a certain age, gender, income level, race, ethnicity, and so on). The key influencer's email addresses will be for people that both have that desired demographic, and who have many “friends” (e.g., Facebook “friends,” or connections). In fact, they are key influencers, in part, because they do have many friends (e.g., at least 1,000).

It is possible that the number of email address collected from a client business needs to be increased. One way to increase the number of email addresses is via a promotion, such as a sweepstakes. A sweepstakes can be conducted in two steps. First, the business can create a cross-platform sweepstakes that is displayed on the client business's Facebook page. Second, the business can invite people to enter the sweepstakes. When someone does enter the client business's sweepstakes, they are asked to “like” the client business's Facebook page, and once they do, the sweepstakes information will be displayed in their News Stream. The end result is that it encourages a client businesses' Facebook and social network friends to enter the sweepstakes, garnering more fans, and creating a community for the client business.

Based upon the demographics of the key influencer for whom the business has an email address, the business can set filters for feeds from location-enabled social networks, popular blogs, forums, Q&A websites, and the like. Location-enabled social networks, popular blogs, forums, Q&A websites, and the like, all have API feeds that contain a vast amount of demographic and/or location data. The business collects all those feeds, and filters the data on them to identify conversations involving people having the desired demographics and location (if it is available) for a client business. For example, the filters could be applied to all the API feeds to collect key words, which key words both determine who constitutes part of a desired demographic, and who is commenting on a product or service that is offered by the client business.

Having the filters set using key influencer demographic characteristics, the business can detect what social network users/potential key influencers are commenting on a site (designated 102). A social network user is anyone on a social network site. The business can also detect what prospects/potential key influencers are commenting on a site (designated 104). A prospect is someone known to have visited a client business. Also, the business can detect any customers/potential key influencers commenting on a site (designated 106). A customer is someone who has spent money at a client business. Additionally, the business can detect any key influencers who are commenting on a site.

As previously mentioned, there are two goals. One goal is to move people down the upper part of the hourglass, to get more customers and key influencers. Another goal is to get each key influencer to recommend the client business to their friends. With regard to the first goal, the business can use the information it collects to provide social network users, prospects, and customers with something that drives them down the social network user-prospect-customer-key influencer part of the hourglass. Since a social network user is primed to receive and review information, the business can send them a newsletter, which will give them information and encourage them to visit the client business—that is, to become a prospect. Since a prospect has visited the client business, he or she knows where it is, so the business can encourage them to become a customer with a coupon. Since a customer has spent money at a client business, the business can encourage them to spend even more money—and/or to think the client business is better than its competitors. Often, giving them a free product will entice them to buy more of a like, or some other, product. If and when the customer gets a lot of friends, he or she will be in a perfect position to recommend the client business to them. The drive to move people down the upper part of the hourglass and the drive for key influencers to recommend the client business to their friends is illustrated by the presence and flow of sand in the hourglass.

The depiction of process 100 as an hourglass also indicates well that the results—more people moved into customer and key influencer roles, and more recommendations from key influencers—improve over the time that the business is engaged to run the process. As the results improve over time, it makes sense for a client business to maximize the amount of time that the business runs process 100 on its behalf.

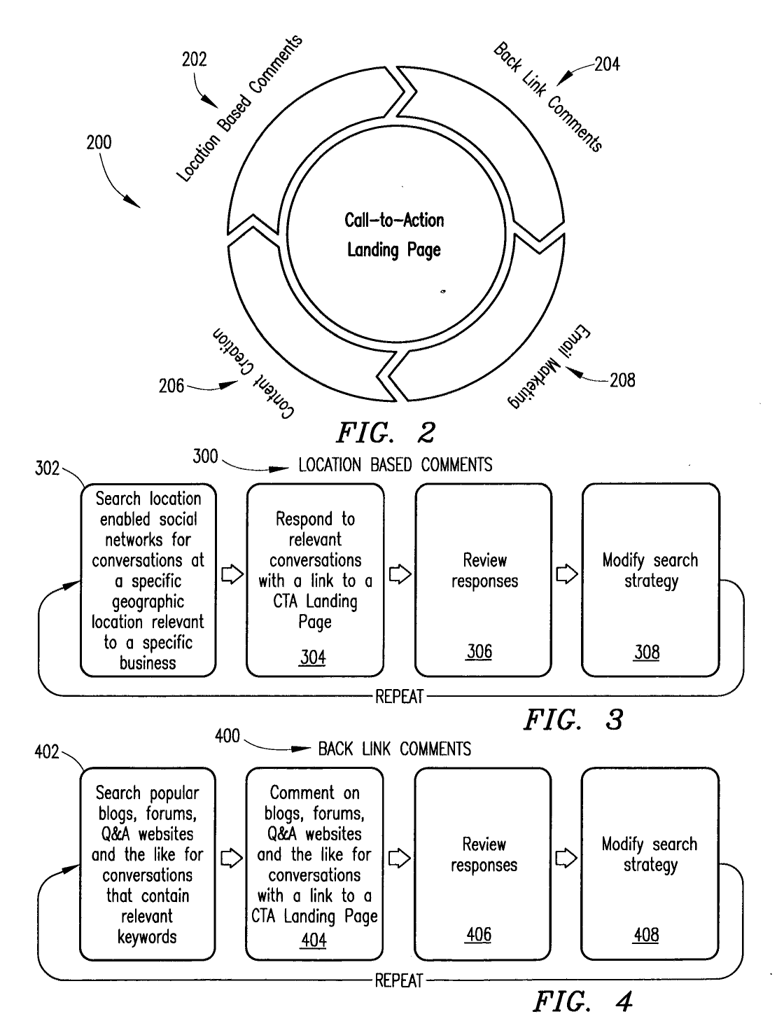

FIG. 2 shows four different ways 200 a business can get detected social network users, prospects, customers and key influencers to achieve the two goals of process 100. The four ways are location based comments 202, back link comments 204, content creation 206, and email marketing 208. The purpose of all four ways (“activity sets”) is to lead a target to a call-to-action landing page 210, by which mechanism people are given more information, invited to become a prospect and customer, and recommend the business to their friends. Making location based comments involves finding local people having online conversations that are relevant to a certain company and turning them into customers. Back link comments involves commenting on popular blogs, forums, and Q&A sites with targeted keyword phrases that link back to a particular website, resulting in the website showing up more frequently on search engines. Content creation involves writing custom shareable content across blogs and social forums that showcases a company's expertise and generates interest in the company. Email marketing involves using attractive, professional-looking email communication to stay in regular touch with prospects and build strong customer relationships.

FIG. 3 shows how the business can make location based comments 202. This process is generally designated process 300. Process 300 begins by the business searching location enabled social networks for conversations at a specific geographic location relevant to a client business 302. This can be accomplished by API feeds being aggregated, detection of key words indicating that a conversation relevant to a client's business is occurring, and detection of location data indicating the conversation is at or about a specific geographic area. Then, at 304, the business can have systems in place so that a commenter can respond to relevant conversations with a link to a call-to-action landing page. As explained below, at the call-to-action landing page visitors are presented with a conversion form they can complete. At 306, the business reviews the responses it receives to its responses. At 308, the business can modify its search strategy to better identify conversations that it can comment on effectively.

Referring now to FIG. 4, there is shown a process 400 by which a business can make back link comments. Back link comments are like location based comments, except location data is not used, and therefore popular blogs, forums, and Q&A websites, rather than location enabled social networks, are searched for conversations that contain relevant key words in the first step 402. At 404 the business uses systems and people to respond to relevant conversations with a link to a call-to-action landing page. At 406 the business reviews the responses it receives to its communications. At 408 the business can modify its search strategy to better identify conversations that it can comment on effectively.

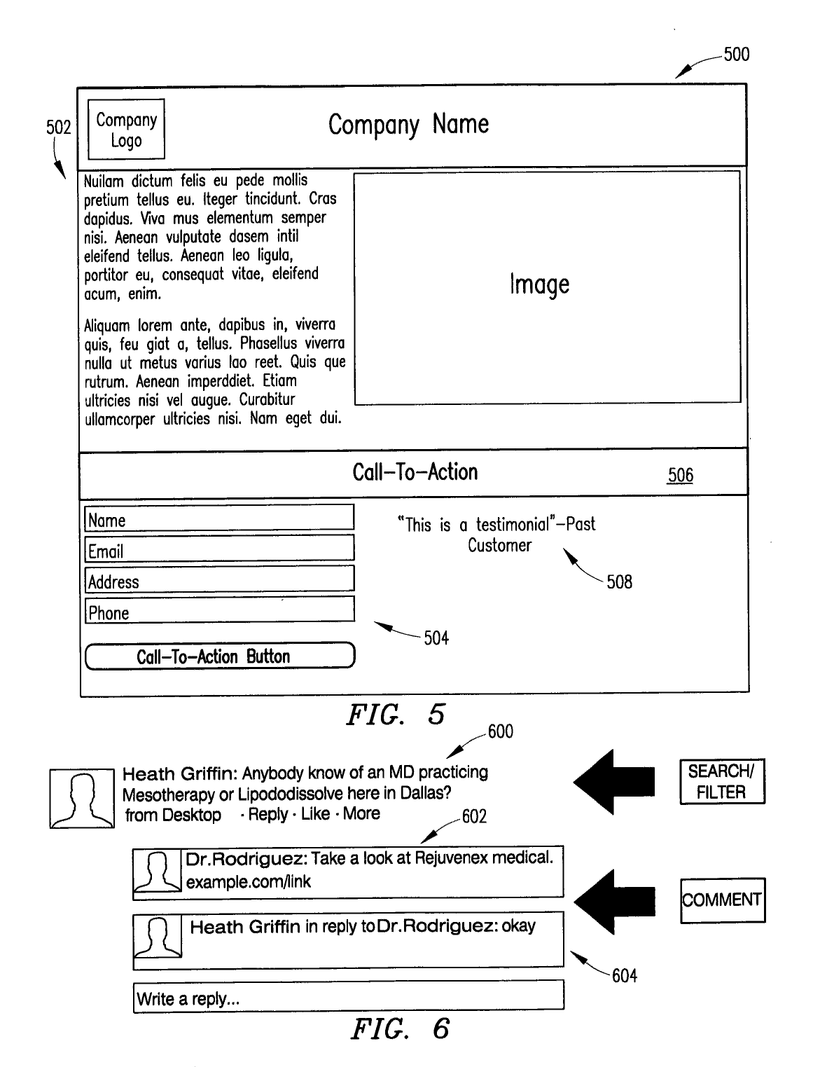

Referring now to FIG. 5, there is shown a call-to-action landing page as referenced in both FIG. 3 and FIG. 4. In cases of both location based comments and back link comments, when a relevant conversation at a location enabled social network, a blog, a forum, or a Q&A website is detected, the response can include a link to a landing page such as pictured and generally designated 500. Landing page 500 includes information about the company 502 as well as a conversion form 504. The conversion form 504 collects information about the person “converting,” such as his or her name, email address, physical address, and phone number. This information is used to increase the size of the total and key influencer email databases previously mentioned. The landing page 500 can also include access to free information 506 to encourage a visitor to convert (an eBook, for example), and information telling the visitor about how good the client business is 508 (a testimonial is pictured).

FIG. 6 shows how the method depicted in FIG. 3 works. In the case of FIG. 6, it is assumed that a client of a business entity is interested in physician who performs mesotherapy or lipodissolve in Dallas, Texas; thus, the filter in FIG. 1 is set up to search for messages containing the word “mesotherapy” or “lipodissolve” that also say or come from Dallas, Texas. At 600 a person posts a message online asking for a referral to a doctor who performs mesotherapy or lipodissolve in Dallas. Because the message posted at 600 indicates both interest and location based on use of the words “mesotherapy” and“lipodissolve” and “Dallas;” it would be detected by the search function 302 in FIG. 3, and the social marketing firm would respond to it as shown by block 304 in FIG. 3. As the message posted at 600 indicates both a select interest and location, a human reviewing the output of a social media filter can deliver a useful comment 602. In the instance depicted in FIG. 6, the useful comment includes a photo of a physician who performs lipodissolve in Dallas, a referral to a medical group (here, Rejuvenex Medical) that does such work, and a link to a call-to-action landing page (here, example.com/link).

Comment 602 is very likely to influence the person who posted at message at step 600 to try the recommended medical group, to try the pictured physician, and to collect further information at the bit.ly/cnybK landing page. The likely success of comment 602 is indicated by the “okay” comment 604 in FIG. 3. 97% of online Americans say that they are more likely to try a product/service if a social network friend recommends it. The method of the present invention puts a business in the same position as a social network friend.

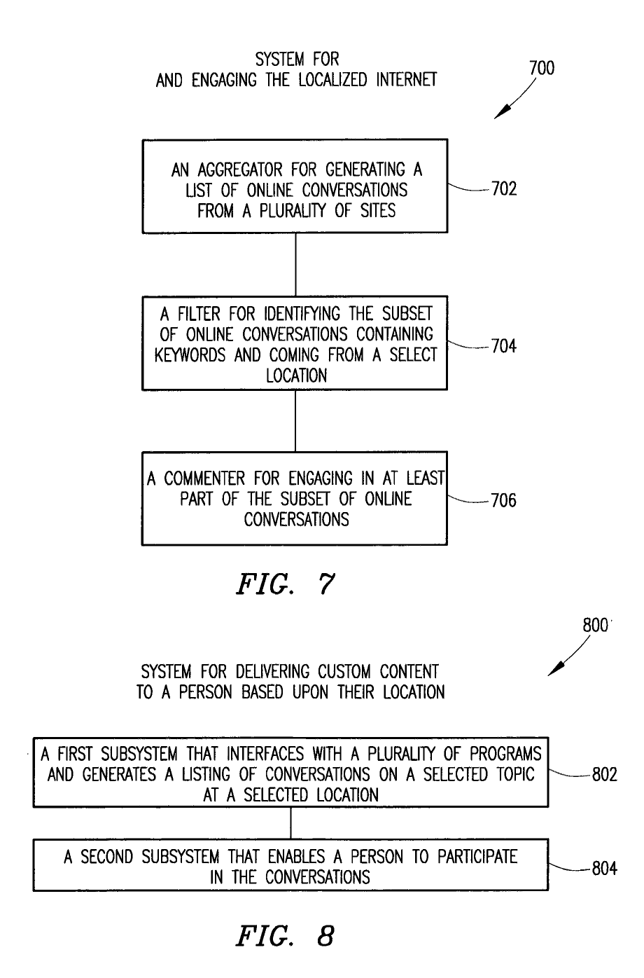

Referring to FIG. 7, a block diagram of a system for engaging the localized

Internet is shown and generally designated 700. System 700 includes an aggregator for generating a list of online conversations from a plurality of sites 702, a filter for identifying the subset of online conversations expressing a select interest by containing keywords and coming from a select location 704, and a commenter for engaging in at least part of the subset of online conversations 706.

Alternatively to filtering for both interest and location, it is possible to search for relevant conversations, and then filter for location. That is, one may search all the popular social networks, blogs, and forums for relevant conversations about a client's products and services. One may then filter those conversations geographically, add custom content, and then broadly distribute the new custom message, driving traffic to a client call-to-action landing page. Thus, one can deliver highly targeted, actionable conversations across the vast network of social media platforms.

Referring to FIG. 8, a block diagram of a system for delivering custom content to a person based on their location is shown and generally designated 800. System 800 includes a first subsystem that interfaces with a plurality of programs and generates a listing of conversations on a selected topic at a selected location 802, and a second subsystem that enables a person to participate in the conversations 804.

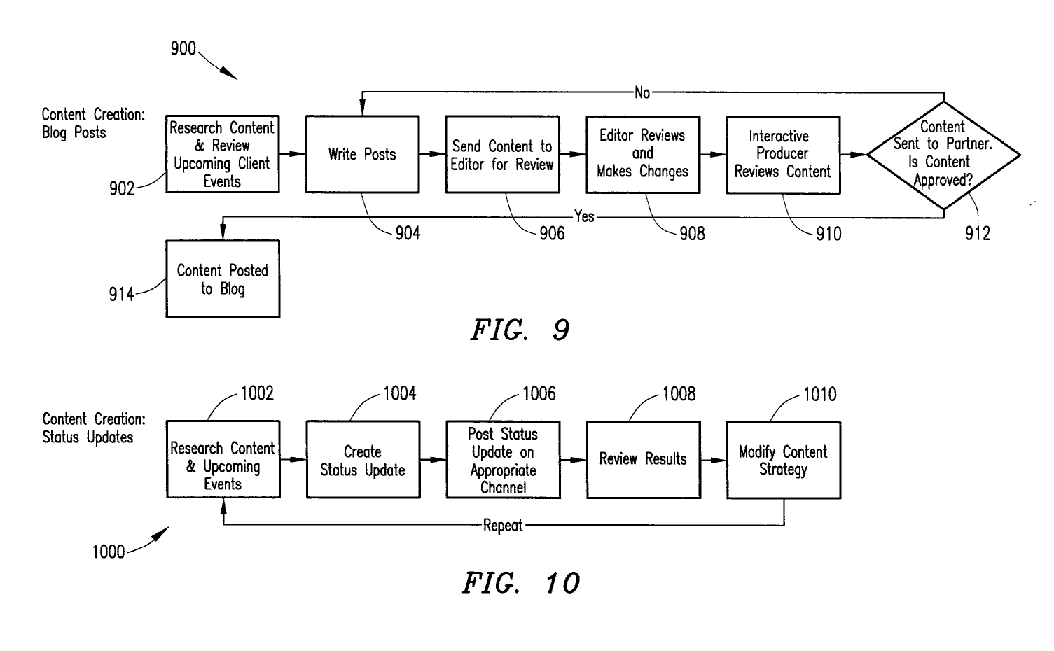

Referring to FIG. 9, a flow chart of a method for posting custom content on a blog is shown and generally designated method 900. Method 900 begins with a review of upcoming client events 902 and creation of posts about them 904. At steps 906, 908, and 910, an editor and an interactive producer review the created post. Next, at step 912, the social media partner handling the client business is asked for his or her review of the post. If the partner approves it, it is posted to a blog 914; if it is not approved, it is rewritten.

In embodiments of the present invention, the business can write blog posts that showcase a client company's expertise, and that solve a target audience's problems. The blog's RSS feed can automatically update the client company's Facebook public profile page, its Twitter account, and the like. People who “like” the client's Facebook page, and/or who follow the client's Twitter account, or the like, can receive a short summary of the blog post with a link to the blog post.

Referring to FIG. 10, a flow chart of a method to update statuses with custom content is shown and generally designated method 1000. Method 1000 begins with the business researching content and upcoming events at the client company 1002. Based upon the results of that research, the business creates a status update 1004. At step 1006, the status update is posted on an appropriate channel. At step 1008, the business reviews the results of the status update, Recognizing that the purpose is to drive interested people at a select location to a custom client landing page, the business can look at various factors, such as the number of comments made and the number of times people accessed the custom client landing page, in making this review. At step 1010, the business can modify its content strategy in order to obtain better-reviewed factors.

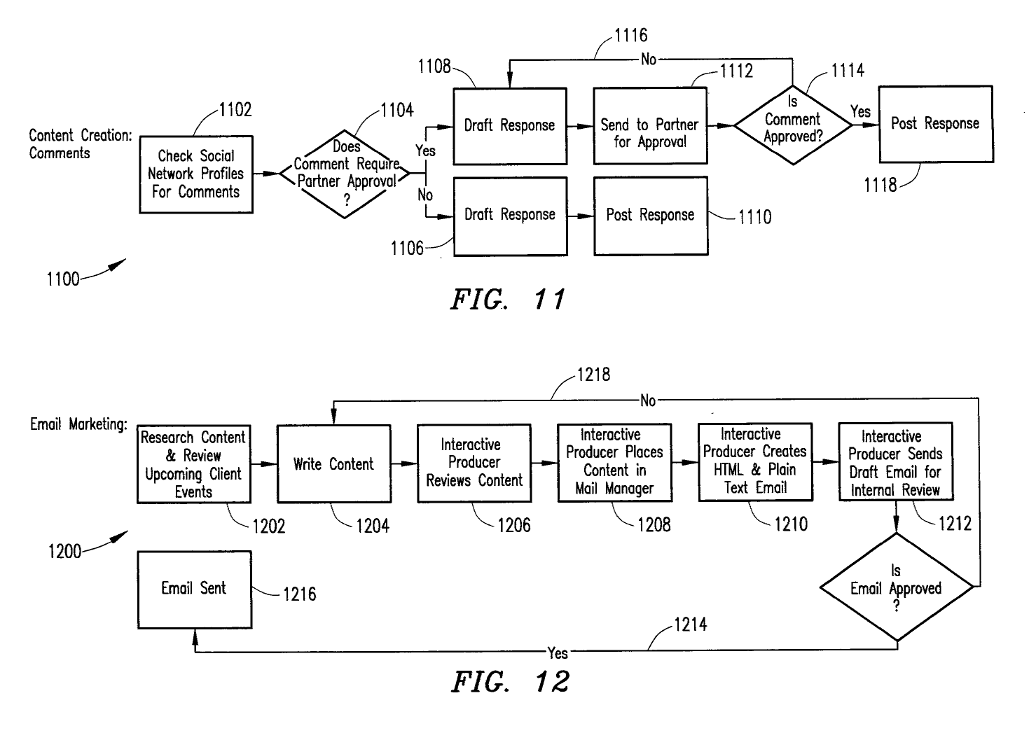

Referring to FIG. 11, a flow chart of a method to comment with custom content is shown and generally designated method 1100. Method 1100 begins with the business (having a “partner” who manages what the business does for a client business) checking all social profiles for comments 1102. At step 1104, the business determines whether a comment requires ultimate partner approval. Whether or not the commented is determined to require such approval, the business drafts a response 1106/1108. If the comment was determined not to require partner approval 1006, the business posts the response 1110. If the comment was determined to require partner approval 1108, the business sends its proposed response to the partner for approval 1112. The partner's determination about whether or not the proposed response is approved is indicated by block 1114. If the comment is not approved 1116, it is redrafted. If the comment is approved, it is posted 1118.

Referring to FIG. 12, a flow chart of a method to conduct an email marketing campaign is shown and generally designated method 1200. Method 1200 begins with the business researching content and reviewing upcoming client events 1202. Based on the results of that research and review, the business writes content that can be emailed 1204. At 1206, an interactive producer at the business reviews the content. At 1208, the interactive producer places the content in an email marketing and email list manager (such as MailChimp). At 1210 the interactive producer creates both HTML and plain text emails. At 1214 the business reviews the draft email. If the email is approved (indicated by line 1214, it is sent (e.g., emailed) 1216. If the email is not approved (indicated by line 1218), it is rewritten.

Email marketing as taught and claimed herein can be very effective—studies should that by adding social network links in email, click-though rates increase five times. By targeting key influencers with email messages including social network links, there is an excellent chance the message is forwarded to many people with a personal recommendation from a trusted friend, which increases the odds of business success even higher.

The system and method of the present invention offer a number of advantages over the prior art. One particular advantage provided by embodiments of the claimed system and method is to enable businesses to deliver highly targeted and actionable conversations across the vast network of social media platforms. Embodiments of the present invention can drive traffic to call-to-action pages, providing trackable, measureable conversion. Embodiments of the present invention give a social template for success and profit. A special advantage of embodiments of the present invention is that a trusted source—a friend—makes recommendations rather than the company itself. Because recommendations come from a trusted source, they resonate with the recipient, and have a much higher success rate than they would if they came from what is generally perceived as a biased source.

Social media is a platform that is easily accessible to anyone with Internet access, opening doors for organizations to increase their brand awareness and facilitate conversations with actual and potential customers. Additionally, social media serves as a relatively inexpensive platform for organizations to implement marketing campaigns. The present invention allows a one-on-one conversation at a specific geographic location with people having conversations relevant to a specific business.

Those of skill will appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A method for marketing, comprising the steps of:
determining characteristics of key influencers;
setting search parameters based upon the determined characteristics;
searching social media feeds for possible key influencers; and
targeting possible key influencers with comments.

2. The method of claim 1, wherein the comments are location based comments.

3. The method of claim 1, wherein the comments are back link comments.

4. The method of claim 1, further comprising the step of creating custom content that appeals to key influencers.

5. The method of claim 4, further comprising the step of posting the custom content on a blog.

6. The method of claim 4, further comprising the step of updating status with the custom content.

7. The method of claim 4, further comprising the step of posting a response to a social profile comment with the custom content.

8. The method of claim 1, further comprising the step of sending email messages including a call-to-action and share buttons to key influencers.

9. A method of conducting an email marketing campaign, comprising the steps of:
identifying a plurality of key influencers; and
sending an email message to the plurality of key influencers, which email message includes a call-to-action and at least one social media share button.

10. A system for engaging social network users, comprising:
an aggregator for generating a list of online conversations about a particular business at a plurality of websites;
a filter for identifying the subset of online conversations about a particular business coming from a select location; and
a commenter for engaging in at least part of the subset of online conversations;
whereby the system enables a one-on-one conversation at or about a specific geographic location with people having a conversation relevant to a particular business.

11. The system of claim 10, wherein the geographic location is defined by a regular geometric shape.

12. The system of claim 10, wherein the geographic location is defined by an irregular geographic shape.

13. A method for engaging social network users comprising the steps of:
aggregating feeds from a plurality of websites to generate a list of online conversations about a particular business;
filtering the list of online conversations by geographic location;
engaging in at least one online conversation regarding a particular business and having a select location;
whereby the method enables a one-on-one conversation at a specific geographic location with people having conversations relevant to a specific business.

14. A system for delivering custom content to a person passed upon their location, comprising:
a first subsystem that interfaces with a plurality of programs and generates a listing of conversations on a selected topic at a selected location; and
a second subsystem that enables a person to participate in the listed conversations.
